(19) United States
(12) Patent Application Publication
(10) Pub. No.: US 2007/0042154 A1
(43) Pub. Date: Feb. 22, 2007

(54) Self-assembled monolayer enhanced DLC coatings

(75) Inventors: Mehmet Hancer, Eagan, MN (US); Jane K. Gates, St. Paul, MN (US); Joel W. Hoehn, Hudson, WI (US); Fang Chen, Eden Prairie, MN (US); Marsha A. Huha, Minneapolis, MN (US); John S. Wright, Minneapolis, MN (US); Lee Walter, Plymouth, MN (US)

Correspondence Address: KINNEY & LANGE, P.A., 312 SOUTH 3RD STREET, THE KINNEY & LANGE BUILDING, MINNEAPOLIS, MN, 55415, US

(73) Assignee: Seagate Technology LLC, Scotts Valley, CA (US)

(21) Appl. No.: 11/586,922

(22) Filed: Oct. 26, 2006

Related U.S. Application Data
(63) Continuation-in-part of application No. 10/700,031, filed on Nov. 3, 2003.
Application No. 10/700,031 is a continuation-in-part of application No. 10/409,385, filed on Apr. 8, 2003, now Pat. No. 6,930,861.

(51) Int. Cl. B32B 3/02

(52) U.S. Cl. 428/64.1

(57) ABSTRACT

A protective coating for a substrate includes a diamond-like carbon (DLC) layer overlying the substrate and having gaps where the substrate is not protected by the diamond-like carbon layer. The protective coating also includes a self-assembled monolayer formed in the gaps of the diamond-like carbon layer.

### CROSS-REFERENCE TO RELATED APPLICATIONS

This application is a continuation-in-part of U.S. patent application Ser. No. 10/700,031, entitled ENCAPSULANT FOR A DISC DRIVE COMPONENT, and filed on Nov. 3, 2003, the disclosure of which is incorporated by reference in its entirety. U.S. patent application Ser. No. 10/700,031 is a continuation-in-part of U.S. patent application Ser. No. 10/409,385, entitled ENCAPSULANT FOR MICROACTUATOR SUSPENSION, and filed on Apr. 8, 2003, the disclosure of which is incorporated by reference in its entirety, and issued on Aug. 16, 2005 as U.S. Pat. No. 6,930,861.

### BACKGROUND OF THE INVENTION

The present invention relates generally to a protective film that coats a metal substrate. More particularly, the present invention relates to a diamond-like carbon (DLC) layer having imperfections that are treatable with a self-assembled monolayer to improve corrosion resistance.

Disc drive storage systems are used for storage of digital information that can be recorded on concentric tracks of a magnetic disc medium. Several discs are rotatably mounted on a spindle, and the information, which can be stored in the form of magnetic transitions within the discs using a write transducer, is accessed using a read transducer. The read and/or write transducer is carried by a slider that is located on an actuator arm that moves radially over the surface of the disc. The slider and transducer can be collectively referred to as a magnetic head.

The discs are rotated at high speeds during operation. As the discs are spun, the slider and the read and/or write transducer glide above the surface of the disc on a small cushion of air. Upon reaching a predetermined high rotational speed, the head floats in air at a predetermined distance from the surface of the disc where it is maintained during reading and recording operations. In order to maximize the high areal recording density, the flying height (i.e. the distance by which the head floats above the surface of the disc) must be minimized.

It is well known in the art to coat the air bearing surfaces of the head and the disc with a diamond-like carbon (DLC) protective overcoat and/or a lubricant layer. The function of the DLC overcoat is to protect underlying metals and alloys from wear and corrosion during the manufacturing process, and throughout the lifetime of the disc drive system. As applied to the head, the DLC overcoat includes a DLC layer and an adhesion layer. As applied to the disc, the DLC layer is applied directly to the disc and a lubricant layer is applied over the DLC layer. DLC overcoat thickness for the head can range from about 20 to 30 Angstroms while typical values of DLC overcoats for magnetic media are in excess of 30 Angstroms. The DLC overcoat thicknesses, along with the lubricant thickness, are one of the largest contributors of head media separation (HMS) distance. The HMS distance is measured from the magnetic surface of the head to the magnetic surface of the media. The HMS distance in turn affects the data reading and writing efficiency of the transducer. Thus, it is important to minimize the DLC overcoat thicknesses.

The DLC layer may be formed using any known thin film deposition technique, and it may be difficult to form a DLC layer that is both ultra-thin and uniform. As such, imperfections are commonly observed in the DLC layer. Such imperfections may inhibit the ability of the DLC layer to protect against corrosion, and thus result in premature failure of the storage systems.

Thus, there is a need for a thin DLC overcoat that decreases HMS distance, thereby increasing recording areal density, while still providing sufficient corrosion resistance.

### BRIEF SUMMARY OF THE INVENTION

The present invention relates to a protective coating for a substrate that includes a diamond-like carbon (DLC) layer overlying the substrate and having gaps where the substrate is not protected by the diamond-like carbon layer, and a self-assembled monolayer formed in the gaps of the DLC layer. The self-assembled monolayer is formed from at least one precursor molecule that preferentially reacts with an exposed portion of the substrate or an exposed portion of an adhesion layer disposed between the substrate and the diamond-like carbon layer.

### BRIEF DESCRIPTION OF THE DRAWINGS

FIG. 1A is a schematic of a portion of a slider of a disc drive, including a read and/or write transducer, and a storage medium.

FIG. 1B is a magnified view of a portion of the slider in FIG. 1A showing a protective overcoat on a surface of the slider.

FIG. 2 is a schematic of a substrate with a protective overcoat applied to an exposed surface of the substrate, illustrating imperfections inherent to the protective overcoat.

FIG. 3 is a schematic of the substrate and protective overcoat of FIG. 2 with a self-assembled monolayer (SAMs) formed in the imperfections of the protective overcoat.

FIG. 4 is a schematic of a single molecule of the self-assembled monolayer of FIG. 3.

FIG. 5 is a schematic illustrating a method of forming a self-assembled monolayer in the imperfections of a protective overcoat.

FIG. 6 is a graph of current as a function of potential to compare the corrosion resistance for a protective overcoat treated with SAMS and an untreated protective overcoat, both having a thickness of 21 Angstroms.

FIG. 7 is a graph of current as a function of potential to compare the corrosion resistance for a treated overcoat and an untreated overcoat, both having a thickness of 15 Angstroms.

FIG. 8 is a graph of current as a function of potential to compare the corrosion resistance for a treated overcoat and an untreated overcoat, both having a thickness of 10 Angstroms.

### DETAILED DESCRIPTION

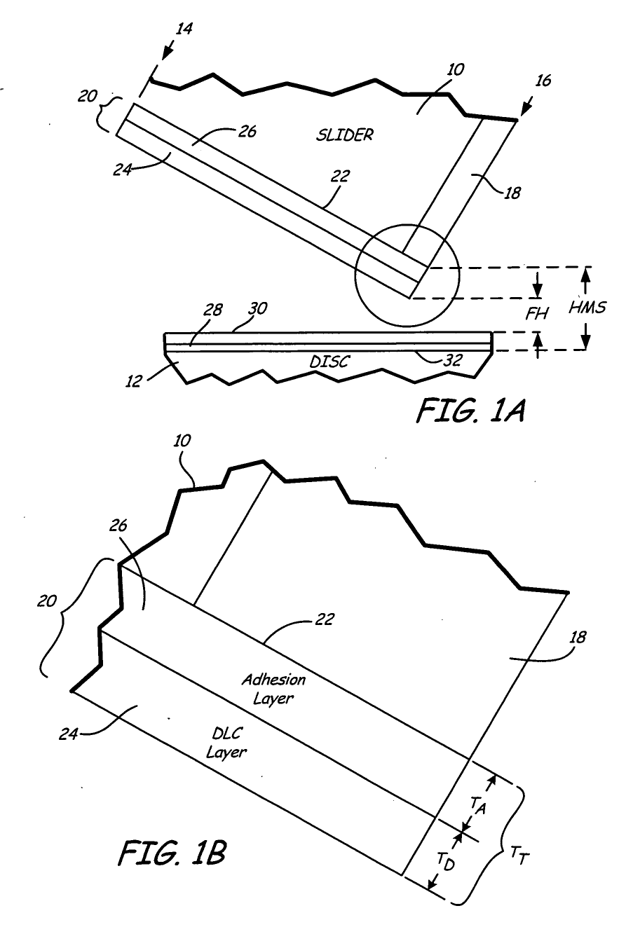

FIG. 1A is a schematic of a portion of slider 10 and magnetic media disc 12 of a disc drive storage system. Slider 10 has leading edge 14 and trailing edge 16, and includes read and/or write transducer 18. Slider 10 and transducer 18 may be collectively referred to as a magnetic head. Protective overcoat 20 is applied to surface 22 of slider 10 and includes diamond-like carbon (DLC) layer 24 and adhesion layer 26. Diamond-like carbon (DLC) layer 28 and lubricant layer 30 are applied to surface 32 of disc 12. Layers 24, 26, 28 and 30 are all exaggerated in thickness for illustrative purposes. As explained in more detail below, specifically with reference to layers 24 and 26, all of these layers are extremely thin.

Slider 10 is connected to a suspension (not shown) including an actuator arm and a load beam that operates to position slider 10 and transducer 18 over a pre-selected data track of the disc. Transducer 18 either reads data from or writes data to the pre-selected data track of disc 12, as disc 12 rotates below slider 10 and transducer 18. Slider 10 is configured such that DLC layer 24 on surface 22 is an air bearing surface that causes slider 10 to fly above the data tracks of disc 12 due to interaction between the air bearing surface of slider 10 and fluid currents that result from rotation of disc 12. As disc 12 reaches its operating rotational velocity, slider 10 pivots such that leading edge 14 of slider 10 rises to a higher level than trailing edge 16 of slider 10, as shown in FIG. 1A. As such, transducer 18 is brought closer to disc 12, which allows more data to be written onto disc 12 and improves the overall electrical performance of the disc drive. However, a minimum clearance between slider 10 and disc 12 must be maintained so that slider 10 does not crash onto disc 12, which is rotating at a high velocity.

As shown in FIG. 1A, fly height FH is a distance or clearance between the air bearing surface of slider 10, which is DLC layer 24, and a surface of disc 12, which is lubricant layer 30. Head media separation HMS is a distance between magnetic surface 22 of transducer 18 and opposing magnetic surface 32 of disc 12. Thus, head media separation HMS includes layers 24 and 26 applied to slider 10 and layers 28 and 30 applied to disc 12. Fly height FH and head media separation HMS are measured when slider 10 and transducer 18 are floating above disc 12, once disc 12 has reached its operating rotational speed.

Protective overcoat 20 is applied to surface 22 of slider 10. Primary functions of overcoat 20 are to protect against wear and corrosion. In particular, it is important to protect the exposed metal parts of transducer 18 which are susceptible to corrosion or oxidation. Layer 24, formed of diamond-like carbon (DLC) is configured to provide corrosion resistance to slider 10. Diamond-like carbon is a preferred material for protective overcoat 20 due to its high hardness, high wear resistance, low coefficient of friction and chemical inertness. DLC layer 24 may not sufficiently adhere to all surfaces, like surface 22 of slider 10. Therefore, adhesion layer 26 is used to attach DLC layer 24 to slider 10.

FIG. 1B is a magnified view of a portion of slider 10 in FIG. 1A showing transducer 18 and protective overcoat 20, including adhesion layer 26 having thickness T_{A}, and DLC layer 24 having thickness T_{D}. Total thickness T_{T} is equal to T_{A} plus T_{D}, and is the thickness of overcoat 20. A person of skill in the art will recognize that adhesion layer 26 and DLC layer 24 will both exhibit some variation in thickness across layers 26 and 24; thus thicknesses T_{A} and T_{D} are an average thickness of layers 26 and 24, respectively. In one embodiment, adhesion layer 26 is selected from one of silicon, alumina, silicon nitride, silica, titanium carbide, metal oxide, and combinations thereof. In other embodiments, adhesion layer 26 may be any type of substance that adheres to surface 22 of slider 10.

DLC layer 24 and adhesion layer 26 may be formed using any known thin film deposition technique, including, but not limited to, chemical vapor deposition, ion beam deposition, evaporation or sputtering. Commonly, adhesion layer 26 is deposited onto surface 22 of slider 10 by physical vapor deposition, and DLC layer 24 is deposited onto adhesion layer 26 by physical sputtering.

A suitable range for total thickness T_{T} of overcoat 20 is between about 10 and 30 Angstroms. Exemplary ranges for total thickness T_{T} include, but are not limited to, about 10 to 21 Angstroms, and about 15 to 25 Angstroms. It may be desirable to decrease or minimize total thickness T_{T} of overcoat 20 in order to decrease HMS distance. However, when total thickness T_{T} is less than about 30 Angstroms, non-acceptable imperfections in DLC layer 24 and adhesion layer 26 may be present. Such imperfections result in surface 22 being exposed to wear and corrosion.

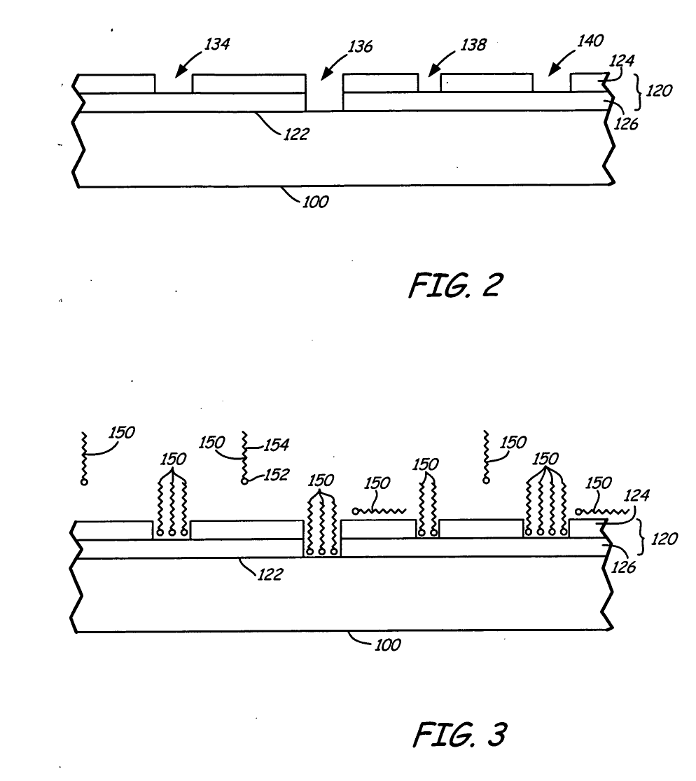

FIG. 2 is a schematic of substrate 100 with protective overcoat 120 applied to exposed surface 122 of substrate 100. Substrate 100 may, for example, be a slider, similar to slider 10 of FIGS. 1A and 1B, or any other component of a disc drive storage system. Moreover, substrate 100 may include any substrate requiring or benefiting from a protective overcoat.

In the embodiment of FIG. 2, protective overcoat 120 includes DLC layer 124 and adhesion layer 126. Adhesion layer 126 may commonly be formed from silicon; however, as described above, other materials and combinations thereof may be used. Protective overcoat 120 also has a plurality of imperfections 134, 136, 138, and 140. (Four imperfections are shown in FIG. 2 for illustrative purposes, but it is recognized that more imperfections may likely be present across DLC layer 124 and adhesion layer 126.) Such imperfections in the form of pin holes or pore defects are inherent to any type of thin film deposition technique, and become more prominent as the thicknesses of DLC layer 124 and adhesion layer 126 are reduced. DLC layer 124 and adhesion layer 126 are commonly formed through physical deposition, and because layers 124 and 126 are very thin, each layer 124 and 126 is comprised, on average, of only a few atomic layers. Probability dictates that there will be areas of each layer 124 or 126 where no atoms or a smaller number of atoms are deposited, resulting in imperfections or gaps in layers 124 and 126.

If there is an imperfection in adhesion layer 126, DLC layer 124 may likely have an imperfection immediately above the gap in adhesion layer 126, as illustrated by defect 136, because DLC layer 124 does not adhere well to surface 122.

As shown in FIG. 2, imperfections 134, 138 and 140 cause portions of adhesion layer 126, which are reactive sites, to be exposed to oxygen, moisture and other molecules that may be energetically attracted to the exposed reactive sites. Similarly, imperfection 136 also results in a portion of reactive surface 122 of substrate 100 to be exposed to these same conditions, all of which cause corrosion. Thus, imperfections 134, 136, 138 and 140 are exposed surfaces which may cause premature failure of a disc drive storage system due to corrosion.

The present invention focuses on repairing the imperfections in DLC layer 124 and adhesion layer 126, thereby improving corrosion resistance without contributing to HMS distance.

Substrate 100 may commonly be any type of magnetic material, for example, nickel, iron, cobalt or combinations thereof. In other embodiments, substrate 100 may be any other type of element. As stated above, adhesion layer 126 may commonly be made of silicon. Exposed portions of surface 122 of substrate 100 and adhesion layer 126 are active molecular sites that create reactive substrates.

Imperfections in DLC layer 124 and adhesion layer 126 may be repaired by treating the exposed surfaces with reactive molecules that will preferentially react with exposed surface 122 and adhesion layer 126, but not react with DLC layer 124. An example of such a reactive molecule is a chemical precursor to a self-assembled mono-layer (SAMs), which may be used to pacify the exposed reactive surfaces resulting from imperfections 134, 136, 138 and 140 of FIG. 2. Two common examples of SAMs chemistries are tridecafluoro-tetrahydrooctyl-trichlorosilane (FOTS) and heptadecafluoro-tetrahydrodecyl-trichlorosilane (FDTS).

The precursor to the self-assembled organic monolayer may commonly include a tri-chloro, tri-methoxy, or tri-ethoxy silane that is bonded to a chain of about four to twenty carbons. The carbon chain may include hydrocarbons, fluorocarbons, and combinations thereof. The silane portion forms a head group of the molecule and the carbon chain forms a tail group of the molecule.

The chemical precursors are reactive molecules with high energy such that they are able to find the exposed surfaces of substrate 100 and adhesion layer 126 caused by imperfections 134, 136, 138, and 140. The head groups of the molecules will form strong bonds with surface 122 and adhesion layer 126, but will not bond to DLC layer 124. Thus, as explained in more detail below, the chemical precursors will form a self-assembled organic monolayer (SAMs) inside imperfections 134-140, but they will not adhere at all to DLC layer 124. Thus, the SAMs will not increase HMS.

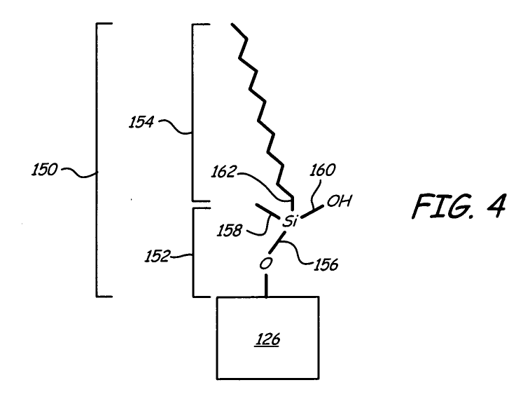

FIG. 3 is a schematic of substrate 100 and protective overcoat 120 of FIG. 2 with a self-assembled monolayer formed in imperfections 134, 136, 138 and 140. Molecules 150 are chemical precursors to SAMs, and as described above, include head group 152 and tail group 154. As shown in FIG. 3, each imperfection 134, 136, 138 and 140 is plugged with at least two molecules 150, with the number of molecules 150 depending on the size of that particular imperfection. As also shown in FIG. 3, once all of imperfections 134, 136, 138 and 140 are plugged, excess molecules 150 remain on or around DLC layer 124, but do not bond to DLC layer 124 or to other molecules 150.

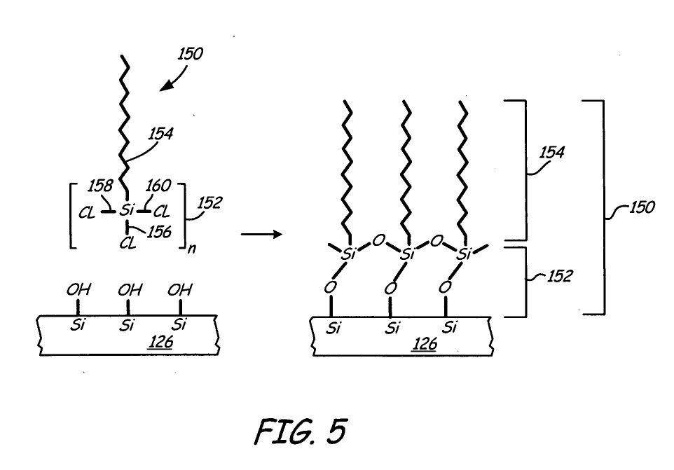

As explained more below in reference to FIGS. 4 and 5, molecules 150 may bond to exposed surface 122 or adhesion layer 126 and cross-link to one another to form the self-assembled monolayer. Because excess molecules 150 do not bond to DLC layer 124 or to each other, the self-assembled monolayer is self-limiting in that molecules 150 themselves dictate that the resulting structure is a single layer. Tail groups 154 are closely packed within each imperfection such that excess molecules 154 or other types of molecules are repelled by tail groups 150. As such, tail groups 154 prevent, for example, water and oils from entering the gaps and reacting with the exposed surfaces.

A portion of tail group 154 of each molecule 150 may be slightly longer or significantly longer than a depth of the imperfection where each molecule 150 resides, depending, for example, on whether there is a gap in both adhesion layer 126 and DLC layer 124 or only DLC layer 124, and the number of carbons in that particular chain. In preferred embodiments, tail group 154 is equal to or slightly larger than a depth of the imperfection. Tail group 154 is soft and bendable such that tail groups 154 of molecules may be folded down flush with DLC layer 124. Alternatively, excess portions of tail groups 154 may be burnished off.

As mentioned above, a significant benefit of the present invention is that forming a self-assembled monolayer in gaps of DLC layer 124 to negate imperfections in protective overcoat 120 does not negatively impact HMS. Moreover, as detailed below, the formation of a self-assembled monolayer on protective overcoat 120, like the embodiment shown in FIG. 3, exhibits improved corrosion resistance compared to a non-treated overcoat having a similar total thickness.

FIG. 4 is a schematic of a single molecule 150 of FIG. 3 bonded to an exposed portion of adhesion layer 126. In this exemplary embodiment, the base group of molecule 150 includes a functional silane molecule. In other embodiments, the base group may be another molecule, such as a functional thiol molecule. As shown in FIG. 4, the silane molecule has four binding/bonding sites denoted as 156, 158, 160, and 162. Sites 156, 158 and 160 are collectively known as head group 152 and site 162 is known as tail group 154. Site 156 represents the actual bonding connection between molecule 150 and adhesion layer 26. Sites 158 and 160 may either bind to an adjacent silane based molecule (cross-linking of molecules 150) or terminate in an OH group. As shown in FIG. 4, site 158 is depicted as available to bind to an adjacent silane based molecule and site 160 is depicted as having a terminating OH group.

In preferred embodiments, head group 152 is made from tridecafluoro-tetrahydrooctyl-trichlorosilane, heptadecafluoro-tetra-hydrodecyl-trichlorosilane, trichloro-silane, trimethoxy-silane, triethoxy-silane, dimethylaminosilane, octadecyltrichlorosilane, dodecyltricholorosilane, and combinations thereof. In other embodiments, head group 152 may be made from any silane or thiol based molecule.

Site 162 is tail group 154, where the about 4 to about 20 carbon tail resides. Tail group 154 further comprises hydrocarbons, fluorocarbons, and combinations thereof. In other embodiments, tail group 154 may comprise any halide or any carbon based molecule.

FIG. 5 is a schematic illustrating a method of forming a self-assembled monolayer inside imperfections of protective overcoat 120 of FIG. 3, starting with molecules 150. The self-assembled monolayer may be formed on exposed surfaces of substrate 100 and adhesion layer 126, which are caused by imperfections in adhesion layer 126 and DLC layer 124. FIG. 5 shows an exposed portion of adhesion layer 126, as an example.

In the exemplary embodiment shown in FIG. 5, head group 152 of molecule 150 is a tri-chlorosilane that is bonded to tail group 154. As stated above, adhesion layer 126 is commonly made of silicon, and in some embodiments, adhesion layer 126 may be composed of silicon oxide. As shown in FIG. 5, adhesion layer 126 includes hydroxyl groups bonded to silicon.

To form the self-assembled monolayer, an exposed surface of adhesion layer 126 is reacted with molecules 150 through at least one of molecular layer deposition, chemical vapor deposition, solution immersion, and combinations thereof. Molecular layer deposition and chemical vapor deposition occur through an atomization process to form a self-assembled monolayer on adhesion layer 126. Liquid or solvent immersion allows adhesion layer 126 to be fully or partially immersed into a solution to form the self-assembled monolayer. In an exemplary embodiment using solvent immersion, the solution may be a non-polar hydrocarbon based solvent.

For each molecule 150, a single functional silane molecule (head group 152) will automatically bind to an exposed hydroxyl group on adhesion layer 126 at site 156 to form a strong bond between molecule 150 and adhesion layer 126. The silane molecule will also subsequently cross-link to two adjacent molecules 150 that are also bonded to adhesion layer 126, as shown in FIG. 5. Cross-linking between molecules 150 may be facilitated by a minute amount of water vapor in the chamber, if a molecular layer deposition or chemical vapor deposition process is used to form the self-assembled monolayer. If liquid or solvent immersion is used to form the self-assembled monolayer, water within the solution may be used to facilitate cross-linking. Sites 158 and 160 of head group 152, which originally contained chloride bonds, may be replaced with hydroxyl groups that allow cross-linking between head groups 152 of adjacent molecules 150.

Regardless of the type of film deposition used, once molecules 150 are deposited onto a surface of adhesion layer 126, they will be self-assembling and cross-linking. A single functional silane molecule will automatically bind to an exposed hydroxyl group on adhesion layer 126 and then subsequently cross-link to two adjacent molecules that are bonded to two adjacent hydroxyl groups on adhesion layer 126. A self-assembled monolayer may be similarly formed on exposed portions of substrate 100 of FIG. 3. In some embodiments, substrate 100 may commonly be formed from a metal oxide; thus, hydroxyl groups, like those shown on adhesion layer 126, facilitate strong bonding between molecules 150 and substrate 100.

Because molecules 150 are self-assembling, they allow for faster film deposition. Because molecules 150 are cross-linking, they provide strength to the self-assembled monolayer. As mentioned above, because the self-assembled monolayer is made up of tightly packed molecules within each gap in the layers of the overcoat, the monolayer functions to repel other molecules from entering the gaps. In this way, the self-assembled monolayer helps the DLC layer to provide corrosion resistance.

A diamond-like carbon layer may also be applied as a protective coating to a magnetic storage medium. In the embodiment shown in FIG. 1A, DLC layer 28 is applied directly to disc 12. DLC layer 28, similar to DLC layers 24 and 124 described and shown above, may also have gaps, causing portions of magnetic surface 32 of disc 12 to be exposed. Gaps in DLC layer 28 may also be plugged or repaired in a similar manner as described above in FIGS. 2 through 5 by forming a self-assembled monolayer in the gaps. The self-assembled monolayer may be formed in the gaps prior to application of lubricant layer 30 over DLC layer 28.

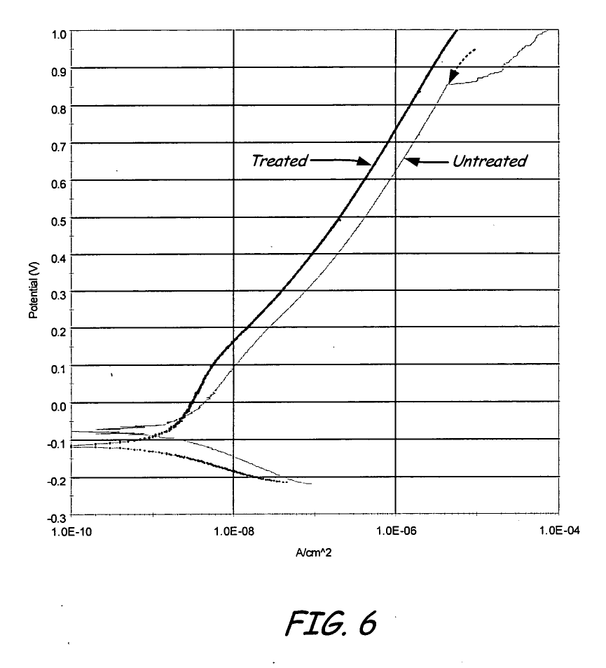

FIG. 6 is a graph of current as a function of potential to compare the corrosion resistance for a protective overcoat treated with SAMS and an untreated protective overcoat, both having a thickness of 21 Angstroms.

A film exhibits better corrosion resistance if it is able to endure a higher current without exhibiting film failure, which includes pitting and other mechanisms indicating a breakdown in the film's ability to resist corrosion. Film failure is indicated when there is an abrupt increase in current at a relatively constant potential. The ability to withstand higher potentials before failure, thus resisting corrosion, is preferred.

In FIG. 6, both the treated and the untreated protective overcoat include a DLC layer and an adhesion layer, with a combined thickness of 21 Angstroms. For the treated overcoat, a self-assembled monolayer (SAMs) has been formed in the gaps in the DLC and adhesion layers in the manner described above.

The untreated protective overcoat exhibited failure at a potential of approximately 0.85 volts. (The broken-line arrow in FIG. 6 shows where film failure occurred for the untreated overcoat.) The SAMs-treated overcoat had not yet exhibited failure at a potential of 1.0 volt.

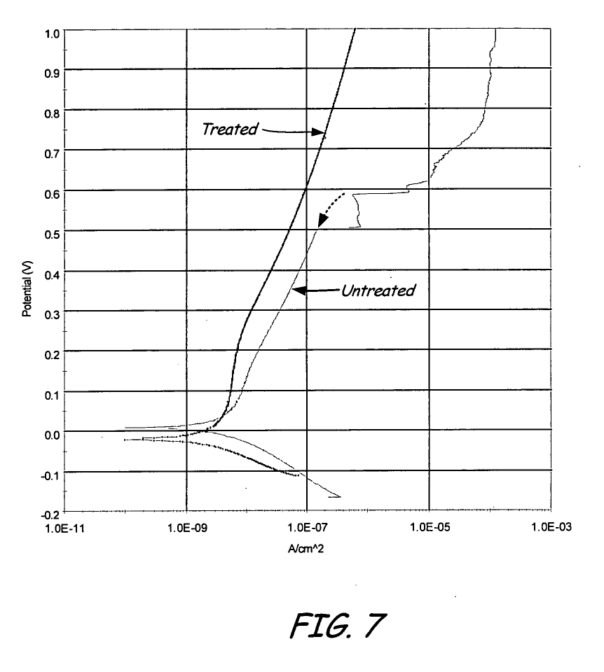

FIG. 7 is another graph of current as a function of potential to compare the corrosion resistance for a SAMs-treated overcoat and an untreated overcoat, both having a thickness of 15 Angstroms. Similar to the protective overcoats in FIG. 6, the thickness of the overcoats includes a DLC layer and an adhesion layer. As shown in FIG. 7, the untreated overcoat exhibited failure at a potential of approximately 0.5 volts, whereas the SAMs-treated overcoat had not yet failed at a potential of 1.0 volt.

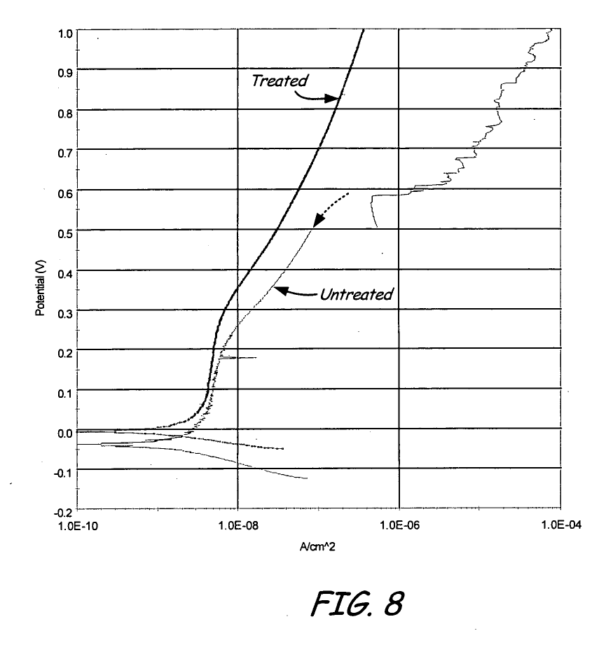

FIG. 8 is a third graph of current as a function of potential comparing corrosion resistance of a treated and untreated overcoat at a thickness of 10 Angstroms. Similar to the results shown in FIGS. 6 and 7, the untreated protective overcoat exhibited film failure at a much lower voltage than the SAMs-treated overcoat. Specifically, the untreated overcoat exhibited failure at a potential of about 0.5 volts and the SAMs-treated overcoat had not yet shown film failure at a potential of 1.0 volt.

The results from FIGS. 6-8 show that the SAMs-treated overcoats have greater corrosion resistance compared to the untreated overcoats, particularly as the thickness of the overcoat is further decreased. At a thickness of 21 Angstroms, imperfections in the DLC and adhesion layers may not be as prominent; thus, the untreated film may be able to withstand higher potentials before failure is observed. However, for thinner overcoats, like those shown in FIGS. 7 and 8, film failure was observed much earlier for the untreated overcoats, whereas the SAMs treated overcoats were still able to withstand higher potentials. By forming a self-assembled monolayer in the gaps in the layers of the protective overcoat, the corrosion resistance of the overcoat is noticeably higher, allowing for thinner films without sacrificing corrosion protection.

The present invention relates to forming a self-assembled monolayer in the gaps of layers of a protective overcoat in order to occupy the exposed reactive sites. Although the present invention has been described above in reference to a protective overcoat for a magnetic read and/or write head, and/or a magnetic storage medium, it is recognized that the present invention could be used in other applications in which a thin, protective overcoat may be preferred or required. For example, the present invention could be used for other parts of a disc drive system or any other type of metal substrate.

Although the present invention has been described with reference to preferred embodiments, workers skilled in the art will recognize that changes may be made in form and detail without departing from the spirit and scope of the invention.

1. A protective coating for a substrate, the protective coating comprising:
a diamond-like carbon layer overlying the substrate and having gaps wherein the substrate is not protected by the diamond-like carbon layer; and
a self-assembled monolayer formed in the gaps of the diamond-like carbon layer.

2. The protective coating of claim 1 wherein the self-assembled monolayer is formed from at least one precursor molecule that preferentially reacts with the substrate.

3. The protective coating of claim 2 wherein each precursor molecule of the self-assembled monolayer comprises a head group and a tail group attached to the head group, and the head group is bondable with the substrate.

4. The protective coating of claim 3 wherein the head group of each precursor molecule is configured to bind to a head group of another precursor molecule such that the self-assembled monolayer is formed in part by cross-linking of the precursor molecules.

5. The protective coating of claim 3 wherein the head group comprises at least one of a functional silane molecule, and a functional thiol molecule.

6. The protective coating of claim 3 wherein the head group is from a group consisting essentially of tridecafluoro-tetrahydrooctyl-tricholorosilane, heptadecafluoro-tetra-hydrodecycl-trichlorosilane, tricholoro-silane, trimethoxy-silane, triethoxy-silane, dimethylaminosilane, octadecyltrichlorosilane, dodecyltricholorosilane, and combinations thereof.

7. The protective coating of claim 3 wherein the tail group comprises from about 4 to about 20 carbons.

8. The protective coating of claim 3 wherein the tail group comprises hydrocarbons, fluorocarbons, and combinations thereof.

9. The protective coating of claim 1 further comprising:
an adhesion layer overlying the substrate and disposed between the substrate and the diamond-like carbon layer, wherein the self-assembled monolayer forms on an exposed portion of at least one of the adhesion layer and the substrate.

10. The protective coating of claim 9 wherein the self assembled monolayer is formed from at least one precursor molecule that preferentially reacts with the exposed portion of at least one of the adhesion layer and the substrate.

11. The protective coating of claim 9 wherein a total thickness of the diamond-like carbon layer and the adhesion layer is less than about 30 Angstroms.

12. The protective coating of claim 9 wherein a total thickness of the diamond-like carbon layer and the adhesion layer is less than about 21 Angstroms.

13. The protective coating of claim 1 wherein the substrate comprises:
a magnetic metal.

14. The protective coating of claim 1 wherein the substrate comprises:
a magnetic storage medium.

15. The protective coating of claim 1 further comprising:
a lubricant layer overlying the diamond-like carbon layer and the self-assembled monolayer.

16. A protective coating comprising:
an adhesion layer overlying a metal substrate;
a diamond-like carbon layer overlying the adhesion layer, wherein a total thickness of the adhesion layer and the diamond-like carbon layer is less than about 30 Angstroms; and
a self-assembled monolayer formed on an exposed portion of at least one of the metal substrate and the adhesion layer between a gap in the diamond-like carbon layer, wherein the self-assembled organic monolayer is formed from at least one precursor molecule that preferentially reacts with at least one of the adhesion layer and the metal substrate.

17. The protective coating of claim 16 wherein each precursor molecule of the self-assembled monolayer comprises a head group that bonds with the adhesion layer or the metal substrate, and a tail group attached to the head group.

18. The protective coating of claim 17 wherein the head group comprises at least one of a functional silane molecule, and a functional thiol molecule.

19. The protective coating of claim 17 wherein the tail group comprises from about 4 to about 20 carbons.

20. The protective coating of claim 16 wherein the adhesion layer is from a group consisting essentially of silicon, alumina, silicon nitride, silica, titanium carbide, metal oxide, and combinations thereof.

21. The protective coating of claim 16 wherein the total thickness of the adhesion layer and the diamond-like carbon layer is less than about 21 Angstroms.

22. The protective coating of claim 16 wherein the total thickness of the adhesion layer and the diamond-like carbon layer is less than about 15 Angstroms.

23. A method of forming a protective coating on a substrate, the method comprising:
depositing a diamond-like carbon layer over the substrate; and
reacting a self-assembled monolayer precursor with an exposed surface in a gap of the diamond-like carbon layer to form a self-assembled monolayer.

24. The method of claim 23 and further comprising:
forming an adhesion layer between the substrate and the diamond-like carbon layer; and
reacting the self-assembled monolayer precursor with at least one of an exposed surface of the adhesion layer and an exposed surface of the substrate to form a self-assembled monolayer.

25. The method of claim 24 wherein the adhesion layer and the diamond-like carbon layer have a total thickness of less than about 30 Angstroms.

26. The method of claim 25 wherein the total thickness is in a range of about 10 to about 21 Angstroms.

27. The method of claim 23 and further comprising:
depositing a lubricant layer over the diamond-like carbon layer and the self-assembled monolayer.

28. The method of claim 23 wherein reacting the self-assembled monolayer precursor to form the self-assembled monolayer comprises at least one of molecular layer deposition, chemical vapor deposition, solution immersion, and combinations thereof.
